(19) United States
(12) Patent Application Publication
(10) Pub. No.: US 2006/0200961 A1
(43) Pub. Date: Sep. 14, 2006

(54) Shaft extractor

(75) Inventor: Gary A. Pinard, Weare, NH (US)

Correspondence Address: MESMER & DELEAULT, PLLC, 41 BROOK STREET, MANCHESTER, NH, 03104, US

(73) Assignee: PYTHON GOLF TOOLS PARTNERSHIP, Manchester, NH (US)

(21) Appl. No.: 11/307,823

(22) Filed: Feb. 24, 2006

Related U.S. Application Data
(60) Provisional application No. 60/656,578, filed on Feb. 25, 2005.

(51) Int. Cl. B23P 19/04

(52) U.S. Cl. 29/252

(57) ABSTRACT

A separation device has a base assembly having a first rail mounted between a first end stop and a second end stop, a carriage slidably mounted on the first rail, a gripping assembly disposed on the carriage wherein a gripping axis of the gripping assembly is parallel with the first rail, a separation member fixedly disposed at the first end stop and aligned with the gripping assembly, and an actuation member mounted to the base assembly and engagable with the carriage where the actuation member moves the carriage along the first rail.

This application claims the benefit of U.S. Provisional Patent Application No. 60/656,578, filed Feb. 25, 2005.

### BACKGROUND OF THE INVENTION

1. Field of the Invention

The present invention relates to a device for separating a component from a shaft. Particularly, the present invention relates to a device for separating a golf club shaft from its associated head.

2. Description of the Prior Art

Golf club shaft and/or club head replacement has been performed for some time. There are many reasons a golf club will need reshafting. These range from the amusing like the argument a club had with a tree, the garage drive over or the knee-shaped club to the more serious like improving performance, changing the feel of a club or the game of the player has advanced beyond the current level of the shaft.

In the field of golf club design, aligning the detected spine of a shaft relative to the face of a club is another reason to remove the shaft from the club head. This is typically performed to improve the club performance or to remove anomalies in the use of the club.

No matter what the reason for separating a club head from a club shaft, several separation devices have been developed. Some are as simple as a vice and a small pry bar. Other devices include a specially designed shaft clamp for use with a small pry bar. The process using these devices has typically been rather time consuming and have not lent themselves to installation in production facility for use in a high production line.

More sophisticated devices known as shaft pullers have also been devised. U.S. Pat. No. 6,336,263 (2002, Weiss et al.) discloses a club shaft and club head separation device for a golf club. The device includes a base having padded shaft gripping members and a separation disk with a disk shaft, the separating disk having at least two peripheral recesses into which the end of a club shaft is inserted, The gripping members are arranged to maintain the club shaft parallel to the axis of the separation disk. A plunger is slidably disposed in a bore in the base and is configured to operably engage the disk shaft. An actuation device is provided to engage the plunger and move the plunger and disk away from the base so that, with the hosel of a club engaging a face of the separation disk, separation of the club shaft and club head will occur.

A disadvantage of the Weiss et al. device is that the mechanism used to engage the gripping members requires manual engagement by a user, i.e. the tightening of a handle having a threaded rod that contacts a movable plate. Another disadvantage is that the separation disk must be rotatable and have multiple recesses to accommodate various shaft diameters.

Therefore, what is needed is shaft puller that has a self-adjusting gripping assembly. What is further needed is a shaft puller that has a single recess in the separation device to accommodate various shaft diameters. What is still further needed is a release indicating mechanism that notifies the user of separation between the club head and club shaft at the moment of release thereby preventing damage to the junction of the club head and club shaft.

### SUMMARY OF THE INVENTION

It is an object of the present invention to provide a shaft extractor having a self-adjusting gripping assembly. It is another object of the present invention to provide a shaft extractor that has a single recess slot in the separation member to accommodate various shaft diameters. It is a further object of the present invention to provide a shaft extractor that includes a release-indicating mechanism that notifies the user of separation between the club head and club shaft at the moment of release thereby preventing damage to the junction of the club head and club shaft. It is still another object of the present invention to provide a shaft extractor that moves the club shaft away from the club head.

The present invention achieves these and other objectives by providing a separation device having a base assembly, a movable carriage, a gripping assembly, a separation member, and an actuation member.

The base assembly includes a bottom support plate, a first end stop, a second end stop, and at least one rail. The rail supports the carriage for movement along the rail between the first end stop and the second end stop. An optional return spring may be included between the carriage and the second end stop to automatically return the carriage to the start position when the actuation member is disengaged.

The carriage includes a carriage front, a carriage back and a gripping assembly portion. The carriage front receives the force applied by the actuation member when separating a shaft from another component fixed thereon. The carriage back contacts the optional return spring when a return spring is included.

The gripping assembly includes a gripping base and gripping jaws. The gripping base has at least one wall with an inner surface that is tapered toward the separation member or an angled portion of the side wall, or both, that tapers toward a gripping axis that is parallel to, and likely concentric with, the shaft being extracted. The gripping jaw associated with the tapered side wall of the gripping base has a right triangular-like shape with an angled side that either matches the taper of the side wall of the gripping base or the angled portion of the side wall, or both. The gripping jaw also has a gripping side that preferably has a non-slip coating or layer to hold the shaft and to prevent marring of the club shaft surface. The opposite side wall of the gripping base may be straight with a non-slip layer or may also incorporate a tapered inner wall surface or an angled portion of the side wall, or both, to accommodate a gripping jaw that is a mirror-image of the gripping jaw of the previously mentioned side wall. The gripping jaw slides along the tapered side wall or the angled portion of the side wall to move the gripping side toward or away from the gripping axis. It should be noted that the gripping assembly may be rotated 90 degrees or 180 degrees for use as a grip replacement clamp for a shaft having a grip component. In addition, the gripping assembly may be removed from the separation device and held by an ordinary bench-type clamping device and used as a quick-release clamping mechanism.

The separation member has a shaft receiving slot with slot sides where a portion of the slot sides angle toward the center line of the shaft receiving slot. The angled portion allows the slot to be used with shafts of differing diameter. The separation member also includes an angled portion of the front face toward the inside of the separation member along a major portion of the shaft receiving slot. The “under cut” angled portion prevents the club head from slipping over the separation member front face and out of the shaft receiving slot when positioned in the separation device and when a separation force is applied by the separation device of the present invention to the shaft. The separation device optionally includes an adjustment slot to adjust the height of the shaft receiving slot relative to the gripping axis of the gripping jaws.

The actuation member includes a push rod that engages the carriage and applies a force against the carriage front in order to separate the shaft from the head. Optionally and preferably, the push rod may be a telescoping push rod having at least two push rod components. A push spring is preferably incorporated on the small push rod component of the telescoping push rod to allow setting a shaft-and-head pre-release force against the carriage. The pre-release force is accomplished by engaging the actuation member and applying sufficient force against the carriage (which is prevented from moving due to the golf club being engaged in the separation member and the gripping jaws) to at least partially compress the push spring. The pre-release force of the push spring causes the carriage to move when the adhesive that is holding the shaft to the head releases. When heat is used to loosen the adhesive, use of the pre-release force of the push spring and movement of the carriage acts as a release indicator so as to prevent overheating of the club head. The actuation member may be a manual device such a levered handle with a push rod, or may be a hydraulic or air driven device or an electric actuator. The actuation member may also be hand-operated or machine-operated.

The separation device of the present invention has several important and key features that include (a) the angled front face of the separation member to prevent a golf club from slipping out of the separation member as pressure is applied to the carriage, (b) the application of force against a movable carriage while maintaining the separation member in a fixed stationary position relative to the carriage, (c) the use of one or more self-adjusting gripping jaws to secure the shaft to the carriage, (d) the use of a push spring to maintain a pre-release pressure against the carriage in order to prevent overheating of the golf head/golf shaft junction by indicating to the user that the adhesive holding the head and shaft has released, and (e) the use of a single, shaft receiving slot of the separation member that accommodates various shaft diameters.

### BRIEF DESCRIPTION OF THE DRAWINGS

FIG. 1 is a side plan view of one embodiment of the present invention.

FIG. 2 is a side plan view of another embodiment of the present invention.

FIG. 3 is a top plan view of the embodiment of the present invention shown in FIG. 1.

FIG. 4 is a top plan view of the gripping jaw members of the present invention.

FIG. 5 is an end view of the gripping jaw members of the present invention shown in FIG. 4.

FIG. 6 is a top plan view of the gripping component assembly of the gripping jaw member of the present invention.

FIG. 7 is an end view of the gripping component assembly of the present invention shown in FIG. 6.

FIG. 8 is an end plan view of the gripping assembly base of the present invention showing the tapered walls.

FIG. 9 is a front plan view of the separation member of the present invention showing the shaft receiving slot.

FIG. 10 is a side view of the separation member of the present invention shown in FIG. 9.

### DETAILED DESCRIPTION OF THE PREFERRED EMBODIMENT

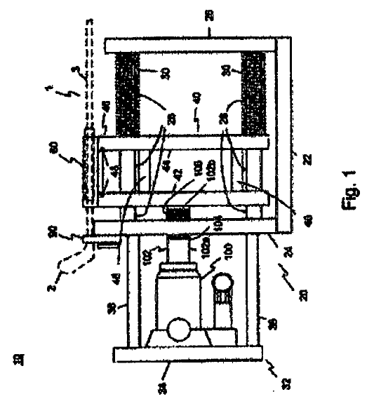

The preferred embodiment(s) of the present invention are illustrated in FIGS. 1-10. FIG. 1 shows the separation device 10 of the present invention. Separation device 10 includes a base assembly 20, a carriage 40, a gripping assembly 60, a separation member 90, and an actuation member 100. A golf club 1 having a club head 2 and a club shaft 3 is shown in dashed lines to indicate the location and positioning of golf club 1 when the separation device 10 of the present invention is used.

Base assembly 20 includes a bottom member 22, a first end stop 24, a second end stop 26, at least one rail 28 and, in this preferred embodiment, a base extension 32. Rail 28 is shown as a circular shaft that extends between first end stop 24 and second end stop 26. It should be understood, however, that rail 28 is not limited to being a circular shaft but may have any shape so long as it is capable of slidably supporting carriage 40 thereon. Rail 28, optionally and preferably, includes a rail spring 30 disposed over a portion of the length of rail 28 or located in base assembly 20 between carriage 40 and second end stop 26. Spring 30 is incorporated to provide a return action to carriage 40 after use and to maintain carriage 40 in the starting/loading position when not in use.

Base extension 32 includes an end plate 34 and one or more connecting rods 36. Connecting rod(s) 36 secure end plate 34 in a spaced relationship with first end stop 24 on a side opposite to the carriage 40 and rail 28. Although one or more connecting rods are used, other structures such as, for example, a plate, an L-bracket, a frame, and the like, may be used to maintain end plate 34 a predefined distance from first end stop 24. In an alternative structure, bottom member 22 may be extended to support end plate 34, which would alleviate the need for connecting rod 36. This alternative embodiment, however, tends to be heavier than the preferred embodiment.

Carriage 40 includes a carriage front 42, a carriage back 44 and one or more carriage spacers 46. Carriage front 42 and carriage back 44 have one or more through holes (not shown) with rail bushings (not shown). Carriage 40 is slidably supported by the rail bushings on rail 28. Although this embodiment uses a pair of upper and lower rails 28, a single rail 28 could be used to support carriage 40 while the remaining “rails” act as only guide rods. As indicated above, rail 28 may have any shape and could include a single rail 28 to support carriage 40 with one or more guide rods (not shown) to maintain the position of carriage 40 on single rail 28. Carriage 40 has a gripping assembly portion 46 for removably supporting gripping assembly 60. Top portion 46 includes opposing carriage slots 48 on the inside surfaces of carriage front 42 and carriage back 44 and are sized to slidably receive and lock into position gripping assembly 60.

Actuation member 100 is removably attached to end plate 34 and includes a push bar 102 that passes through an opening (not shown) in first end stop 24 and contacts carriage front 42. Actuation member 100 is engagable to cause a pushing pressure against carriage front 42 using push bar 102. In a preferred embodiment, push bar 102 has at least two telescoping bar components with an optional push spring 106 that rests against a spring stop 104 on push bar 102.

Push spring 106 is considered a release indicating mechanism when used. When the golf club 1 is loaded onto separation device 10, actuation member 100 with the optional push spring 106 engages carriage front 42 and is partially compressed placing a force against carriage front 42 proportional to the amount of compression of push spring 106. As an energy source such as, for example, heat is applied to the junction of the club head 2 and club shaft 3 and as the junction reaches a predetermined temperature for separation to occur, the force imparted onto carriage front 42 by push spring 106 causes carriage 40 to move the club shaft 3 away from club head 2 before overheating of the junction occurs and, thus, provides an indication of release before a user overheats the junction.

Actuation member 100 may by simply a leveraged handle with a push rod or, preferably, a hydraulic jack-like device. Actuation member 100 may be manually operated or machine operated. It may also be air activated or electrically actuated.

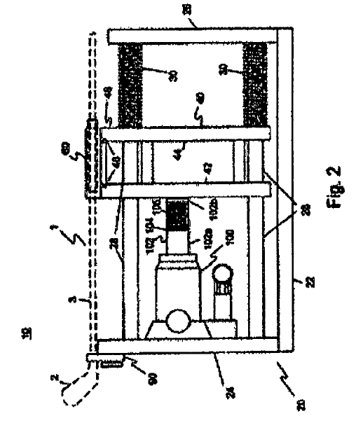

Turning now to FIG. 2, there is shown another embodiment of the present invention. In this embodiment like the embodiment in FIG. 1, separation device 10 includes a base assembly 20, a carriage 40, a gripping assembly 60, a separation member 90, and an actuation member 100. Base assembly 20 includes a bottom member 22, a first end stop 24, a second end stop 26, and at least one rail 28. Rail 28 extends between first end stop 24 and second end stop 26 and supports carriage 40. Carriage 40 slides along rail 28 and preferably includes return spring 30. Gripping assembly 60 and separation member 80 are the same and positioned similarly as they are in FIG. 1 relative to carriage 60 and first end stop 24, respectively. Unlike the embodiment in FIG. 1, this embodiment has actuation member 100 secured against the inside surface of first end stop 24 and, thus, does not require the use of an end plate 24 and connecting rod 28.

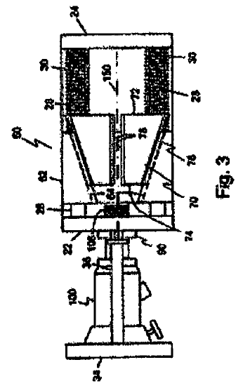

FIG. 3 is a top view of the embodiment in FIG. 1. As can be seen from FIG. 3, griping assembly 60 includes a gripping assembly base 62 and a gripping jaw component 70 slidably connected to gripping assembly base 62. Gripping assembly base 62 has tapered side walls 64 that taper toward the separation member 80. Gripping jaw component 70 includes first and second gripping jaws 72 that slidingly engage the tapered side walls 64. The space 73 between first and second gripping jaws 72 defines the golf shaft gripping area having a gripping axis 150 that is centered through gripping assembly 60 and aligned with separation member 90. First and second gripping jaws 72 each have a right-triangular shape with a blunted end 74, a side wall engaging side 76 and a gripping side 78. Side wall engaging side 76 slidingly engages side wall 64 to adjust to varying club shaft sizes. Pressure from actuation member 100 against carriage 40 when golf club 1 is placed in separation member 80 and gripping assembly 60 causes the gripping jaws 72 to tighten against club shaft 3. This occurs because the tapered arrangement of the base side walls 64 and sides 76 of gripping jaws 72 causes the gripping jaw 72 to move toward gripping axis 150 tightening jaws 72 against club shaft 3 as a force is applied to carriage 40 by actuation member 100.

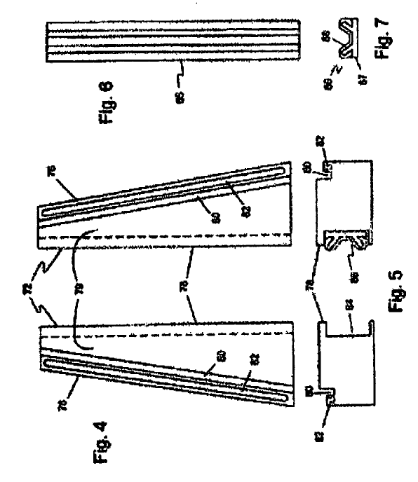

FIG. 4 shows an enlarged top plan view of gripping jaws 72. Each side wall engaging side 76 of gripping jaws 72 has a jaw guide channel 80 and a jaw retaining channel 82 that are parallel to each other and formed in the jaw top surface 79 spaced from side wall engaging side 76. Jaw guide channel 80 extends the entire length of gripping jaw 72 and is sized to receive a mating lip 66 formed in associated side wall 64. Jaw retaining channel 82 is an enclosed channel that receives a removable stop pin (not shown) in side wall 64. When the stop pin is inserted, the ends of jaw guide channel 82 prevents gripping jaw 72 from sliding completely out of gripping base 62. It should be noted that side walls 64 of gripping assembly 60 need not be tapered since the use of jaw guiding channel 80 and mating lip 66 will hold gripping jaw 72 in proper position. Tapering side walls 64 simply adds additional support and reduces the probability of breaking or damaging mating lip 66.

FIG. 5 shows an end view of gripping jaws 72. Gripping jaw 72 also has a gripping side 78 that includes a gripper channel 84. Gripper channel 84 is configured to receive a replaceable gripper surface assembly 86. Gripper surface assembly 86 contacts the club shaft and holds it during golf head removal. FIG. 6 is a top plan view of gripper surface assembly 86. Gripper surface assembly 86 is preferably about the length of gripping side 78, but may be longer or shorter as desired. The preferred length of gripper surface assembly 86 is about 4 inches, which has been determined to provide a sufficient holding surface for gripping the club shaft 3. FIG. 7 is an end view of gripper surface assembly 86 showing gripper surface assembly 86 as a two-part assembly. Gripper surface assembly 86 includes a gripper assembly base 87 and a gripper assembly covering 88. Gripper assembly covering 88 is preferably a resilient material having relatively good frictional, non-slip properties to prevent slippage and non-scratching characteristics to prevent any scratching or marring of the club shaft surface. The upper face of gripper assembly base 87 has a V-like shape to provide an area that will contact a correspondingly larger surface area of the club shaft. Gripper assembly covering 88 is preferably made of rubber or neoprene to provide a padded area for gripping the club shaft but any natural or man-made material having the required non-slip and non-scratching characteristics may be used.

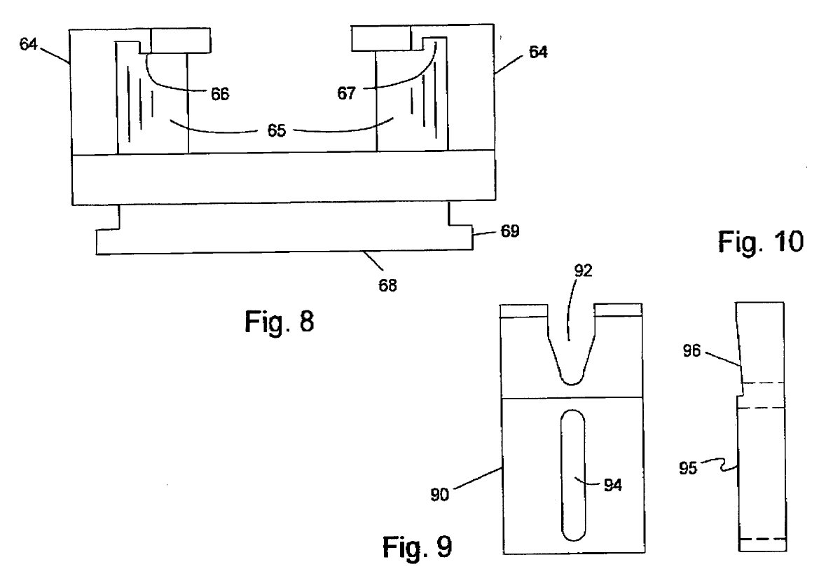

Turning now to FIG. 8, there is shown an end view of gripping assembly base 62. Gripping assembly base 62 has base side walls 64 and a base bottom portion 68. Base side walls 64 have a tapered thickness forming a tapered inside wall surface 65. Base side walls 64 also have a side wall mating lip 66 forming a jaw receiving channel 67 along the top side of tapered inside wall surface 65. As previously explained, side wall mating lip 66 is received into jaw guiding channel 80 of gripping jaw 72. It is noted that gripping assembly base 62 may have only one side wall 64 with a tapered inside surface while the other side wall may be substantially straight and accommodating a parallel-sided gripping jaw 72. Further, parallel-sided gripping jaw 72 may be static or fixed to side wall 64 Gripping base portion 68 has an extending base ledge portion 69 along two opposing sides but optionally, and preferably, along a portion of each side of gripping base portion 68. Base ledge portion 69 slidingly engages carriage slots 48 to support gripping assembly 60 on carriage 40. Having base ledge portion 69 on each side allows the gripping assembly 60 to be positioned at 90 degrees or 180 degrees to the separation member 90. This is particularly useful when the grip on the club handle is being replaced. The gripping jaws 72 will hold the club shaft while the replacement grip is being mounted onto the club shaft. It should also be noted that gripping assembly 60 may be removed from separation device 10 and placed into some other holding device such as, for example, a bench-type vise for use as a quick-release clamping mechanism.

FIG. 9 is a front view of separation member 90. Separation member 90 has a shaft receiving slot 92 in one side of separation member 90 and an adjusting channel 94. Adjusting channel 94 in conjunction with shoulder bold (not shown) or other retaining device allows the separation member 90 to be height adjusted to proper align with the gripping axis 150. Shaft receiving slot 92 is partially V-shaped with a rounded bottom for receiving shafts of various diameters. FIG. 10 is a side view of the separation member 90 shown in FIG. 9. As seen, separation member 90 has a portion 95 of front face 96 angled toward the inside of separation member 90. This configuration prevents the golf club from slipping out of separation member 90 once tension is place on carriage 40 by actuation member 100. With the club head up against portion 95 of front face 96, the angled surface prevents the club from slipping up the front face 96 as force is applied against carriage 40.

Use of the present invention is accomplished in the following manner. Observe that the actuation member 100 is in a fully released position so that no force is placed against carriage front 42. If not, then actuation member 100 must be disengaged. Open the gripping jaws 72 by sliding the jaws back away from the separation member 90 providing a sufficient opening to insert the club shaft 3 of a golf club 1. Dispose golf club 1 between the gripping jaws 72 and into shaft receiving slot 92 of separation member 90 so that the golf head 2 is in front of separation member 90 and the hosel of the club head butts up against portion 95 of front face 96 of separation member 90. Once positioned, gripping jaws 72 are moved toward separation member 90 to snug the gripper surface assembly 86 of gripping side 78 to golf shaft 3. Now, engage actuation member 100 so that push bar 102 engages carriage front 42.

Once engaged with carriage front 42, increase the force against carriage front 42 by observing the contraction of push spring 106 indicating that a continuous force is being applied to carriage front 42. This action causes carriage 40 to slide a very short distance, if any, along rail 28 tightening gripping laws 72 about club shaft 3 since the golf club 1 is held in a stationary position by separation member 90 Portion 95 of separation member front face 96 prevents the club head 2 from slipping up the front face 96 due to the force placed against carriage 40. Next, heat is applied to the junction, i.e. the hose, of club head 2 and club shaft 3 to loosen the adhesive holding the head and shaft together.

Once a sufficient amount of heat is applied to cause the adhesive to release and before overheating occurs, the force applied against carriage 60 by push spring 102 of actuation member 100 causes the carriage to move away from separation member 90 a short distance. This indicates to the user that the adhesive has released and that heating may be discontinued. The user then continues engaging actuation member 100 to complete the separation of club shaft 3 from club head 2. After being separated, club shaft 3 is released from gripping jaws 72 by pulling club shaft 3 away from separation member 90 causing gripping jaws 72 to slide back along gripping base 62 and opening the space between the gripping surface assembly 86 of each jaw and releasing golf shaft 3. Upon removal of golf shaft 3, actuation member 100 is disengaged from carriage 40, allowing carriage return spring 30 to return carriage 40 to its start position ready to perform the shaft removal on another golf club.

It is important to note that the present invention incorporates several unique aspects. These include (a) the angled portion 95 of front face 96 of separation member 90 to prevent a golf club from slipping out of separation member 90 as pressure is applied to carriage 60, (b) the application of force against a movable carriage 60 while maintaining the separation member 90 in a fixed stationary position relative to carriage 60, (c) the use of one or more self-adjusting gripping jaws 72 to secure the shaft to the carriage 60, (d) the use of a push spring 102 to maintain a pre-release pressure against carriage 60 in order to prevent overheating of the golf head/golf shaft junction by indicating to the user that the adhesive holding the head and shaft has released, and (e) the use of a single, shaft receiving slot 92 of separation member 90 that accommodates various shaft diameters.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A separation device comprising:
a base assembly having a first rail mounted between a first end stop and a second end stop;
a carriage slidably mounted on said first rail;
a gripping assembly disposed on said carriage wherein a gripping axis of said gripping assembly is parallel with said rail;
a separation member fixedly disposed at said first end stop and aligned with said gripping assembly; and
an actuation member mounted to said base assembly and engagable with said carriage wherein said actuation member moves said carriage along said first rail.

2. The device of claim 1 further comprising a spring mounted on said rail between said carriage and said second end stop.

3. The device of claim 1 further comprising an actuation member spring mounted on a movable shaft of said actuation member, said movable shaft having a distal shaft end that engages said carriage.

4. The device of claim 3 wherein said movable shaft passes through an opening in said first end stop.

5. The device of claim 1 wherein said gripping assembly includes a gripping assembly base with a pair of opposed side walls wherein an inside first wall surface of a first side wall of said pair of side walls is tapered along said gripping axis toward said separation member, and a first gripping jaw slidably connected with said tapered side wall forming a shaft gripping area between a first gripping surface of said first gripping jaw and an inside second wall surface of a second side wall of said pair of opposed side walls.

6. The device of claim 5 wherein said first gripping jaw has a resilient pad on said gripping surface.

7. The device of claim 5 further comprising a second opposed gripping jaw slidably connected to a tapered inside second wall surface wherein said taper is along said gripping axis toward said separation member and wherein said second opposed gripping jaw has a second gripping surface.

8. The device of claim 7 wherein said second gripping jaw has a resilient pad on said second gripping surface.

9. The device of claim 5 wherein said gripping assembly is removably connected to said carriage.

10. The device of claim 1 wherein said separation member has a slot aligned with said gripping axis.

11. The device of claim 1 wherein said actuation member is mounted on an inside surface of said first end stop.

12. The device of claim 1 wherein said actuation member is mounted on said base assembly spaced from an outside surface of said first end stop.

13. The device of claim 1 wherein said separation member is a slot in a top edge of said first end stop.

14. A method of separating a shaft from a component, said method comprising:
placing said component on one side of a stationary separation member wherein said shaft is positioned in a slot of said stationary separation member;
securing said shaft in a gripping assembly mounted to a slidable carriage wherein said griping assembly is axially aligned with said stationary member;
applying an energy source to the junction of said component and said shaft; and
moving said carriage away from said stationary member.

15. The method of claim 14 further comprising engaging said slidable carriage with an actuation member having an actuation shaft wherein said shaft pushes said slidable carriage.

16. The method of claim 15 wherein said engaging step further includes engaging a release indicating shaft compression spring mounted on said actuation shaft to preload a compression force against said carriage prior to applying said energy source to the junction of said component and said shaft.

17. A separation device having a shaft gripping member, a separation member, and an actuation member for separating a club shaft from a club head to which a club head is attached, the improvement comprising:
a self-adjusting gripping assembly for gripping said club shaft, said gripping assembly comprising:
a gripping assembly base with a pair of opposed side walls wherein an inside first wall surface of a first side wall of said pair of side walls is tapered; and
a first gripping jaw having a right-triangular shape wherein said tapered side of said right-triangular shaped gripping jaw is slidably connected with said tapered side wall forming a shaft gripping area between a first gripping surface of said first gripping jaw and an inside second wall surface of a second side wall of said pair of opposed side walls, wherein said first gripping jaw and said inside second wall surface form an elongated gripping surface that is self-adjusting as said shaft and said first gripping jaw is moved in the direction towards said inside second wall surface.

18. The separation device of claim 17 wherein said first gripping jaw has a resilient pad on said first gripping surface.

19. The separation device of claim 17 further comprising a second opposed gripping jaw slidably connected to a tapered inside second wall surface wherein said taper is a mirror image of said first tapered side wall and wherein said second opposed gripping jaw has a second gripping surface.

20. The separation device of claim 19 wherein said second gripping jaw has a resilient pad on said second gripping surface.

21. The separation device of claim 17 wherein said self-adjusting gripping assembly is rotable to a 90 degree or a 180 degree position.
